(19) United States
(12) Patent Application Publication
(10) Pub. No.: US 2010/0118190 A1
(43) Pub. Date: May 13, 2010

(54) CONVERTING IMAGES TO MOVING PICTURE FORMAT

(75) Inventors: Roni Salfati, Hod Hasharon (IL); Ron Perry, Bnei Zion (IL); Gadi Inon, Rosh Ha'ayin (IL); Amir Shatz, Zur Yigal (IL)

Correspondence Address: EDWARDS ANGELL PALMER & DODGE LLP, P.O. BOX 55874, BOSTON, MA, 02205, US

(73) Assignee: Mobixell Networks, Ra' anana (IL)

(21) Appl. No.: 12/526,185

(22) PCT Filed: Jan. 29, 2008
(86) PCT No.: PCT/IL08/00128

§ 371 Date: Jan. 19, 2010

Related U.S. Application Data
(60) Provisional application No. 60/899,927, filed on Feb. 6, 2007.

(51) Int. Cl. H04N 7/04; G06T 13/00

(52) U.S. Cl. 348/469; 345/473; 348/E05.051

(57) ABSTRACT

A method for content delivery includes receiving a request for delivery of a still image to a client terminal. A promotional image is selected to be delivered to the client terminal together with the still image. The still image and the promotional image are processed together so as to create an image sequence containing the still image and the promotional image in a moving picture format. Responsively to the request for delivery of the still image, the image sequence is delivered over a network for display in the moving picture format by the client terminal.

### CROSS-REFERENCE TO RELATED APPLICATION

This application claims the benefit of U.S. Provisional Patent Application 60/899,927, filed Feb. 6, 2007, which is incorporated herein by reference.

### FIELD OF THE INVENTION

The present invention relates generally to multimedia distribution and specifically to methods and systems for transmission of images over digital communication networks.

### BACKGROUND OF THE INVENTION

Multimedia-enabled cellular phone systems enable users of phones (also referred to as handsets) to receive multimedia content, including objects such as pictures, music, video, and executable programs. Multimedia Messaging Service (MMS) enables phone users to send and to receive multimedia messages that encapsulate multimedia content. Users of phones with packet network communication capabilities may also download content to their phones from other sources, such as Web servers, using protocols such as the Wireless Access Protocol (WAP).

Network content and service providers sometimes add advertisements to content that is delivered to subscribers. For example, PCT International Publication WO 01/93161, whose disclosure is incorporated herein by reference, describes an online multimedia system in which targeted advertisements are delivered to users. Ad insertion, as described in this publication, is a process in which one or more advertisements are inserted in one or more archived video streams or live video broadcasts. The publication describes an Ad Insertion Platform, which inserts audio/video advertisements (or GIF/Flash® ads) before, during or after archived video content, eliminating the need to host the ad and video on the same server. The central servers host the ads and intelligently insert, or control insertion of them, into the presented video stream.

### SUMMARY OF THE INVENTION

Modern client terminals, such as cellular telephones and computing devices, are capable of receiving and playing sophisticated multimedia objects, including animations and video sequences. Content and service providers may readily insert advertisements in animations and video sequences simply by adding appropriate frames to the existing sequence. On the other hand, when a client terminal is to receive a still image, the media format—a single frame—does not lend itself to insertion of full-frame advertisements.

Embodiments of the present invention address this issue by converting a requested still image into an image sequence in a moving picture format, such as an animation or video format. An ad injector selects an advertisement, in the form of a promotional image, to be delivered to the client terminal together with the still image, and processes the still image and the promotional image together so as to create the image sequence, which is then delivered to the client terminal.

There is therefore provided, in accordance with an embodiment of the present invention, a method for content delivery, including:

receiving a request for delivery of a still image to a client terminal;

selecting a promotional image to be delivered to the client terminal together with the still image;

processing the still image and the promotional image together so as to create an image sequence containing the still image and the promotional image in a moving picture format; and

responsively to the request for delivery of the still image, delivering the image sequence over a network for display in the moving picture format by the client terminal.

In some embodiments, processing the still image and the promotional image includes adjusting at least one image parameter of at least one of the still image and the promotional image relative to the other of the images. The at least one image parameter may be selected from a group of parameters consisting of an aspect ratio, a resolution, a palette, a brightness, a contrast, a color saturation, and an orientation. Typically, adjusting the at least one image parameter includes modifying at least one of the still image and the promotional image so that the still image and the promotional image have the same resolution and aspect ratio.

In one embodiment, processing the still image and the promotional image includes assigning respective display times of the still image and the promotional image in the image sequence. Additionally or alternatively, processing the still image and the promotional image includes introducing one or more additional frames into the image sequence so as to generate a transition effect between the promotional image and the still image.

The promotional image may be generated by converting textual content to an image format. Converting the textual content may include selecting a size of the image format for the textual content responsively to at least one attribute selected from a group of attributes consisting of image parameters of the still image and a characteristic of the client terminal.

The moving picture format may include an animation format or a video format.

There is also provided, in accordance with an embodiment of the present invention, apparatus for content delivery, including:

a communication interface; and

a processor, which is coupled to the communication interface so as to receive a request for delivery of a still image to a client terminal, and is configured to select a promotional image to be delivered to the client terminal together with the still image, to process the still image and the promotional image together so as to create an image sequence containing the still image and the promotional image in a moving picture format, and to deliver the image sequence, responsively to the request for delivery of the still image, over a network for display by the client terminal in the moving picture format.

There is additionally provided, in accordance with an embodiment of the present invention, a computer software product, including a computer-readable medium in which program instructions are stored, which instructions, when read by a computer processor, cause the processor to receive a request for delivery of a still image to a client terminal, and to select a promotional image to be delivered to the client terminal together with the still image, to process the still image and the promotional image together so as to create an image sequence containing the still image and the promotional image in a moving picture format, and to deliver the image sequence, responsively to the request for delivery of the still image, over a network for display by the client terminal in the moving picture format.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for content delivery, in accordance with an embodiment of the present invention; and

FIG. 2 is a flow chart, which schematically illustrates a method for converting a still image into an image sequence in a moving picture format, in accordance with an embodiment of the present invention.

### DETAILED DESCRIPTION OF EMBODIMENTS

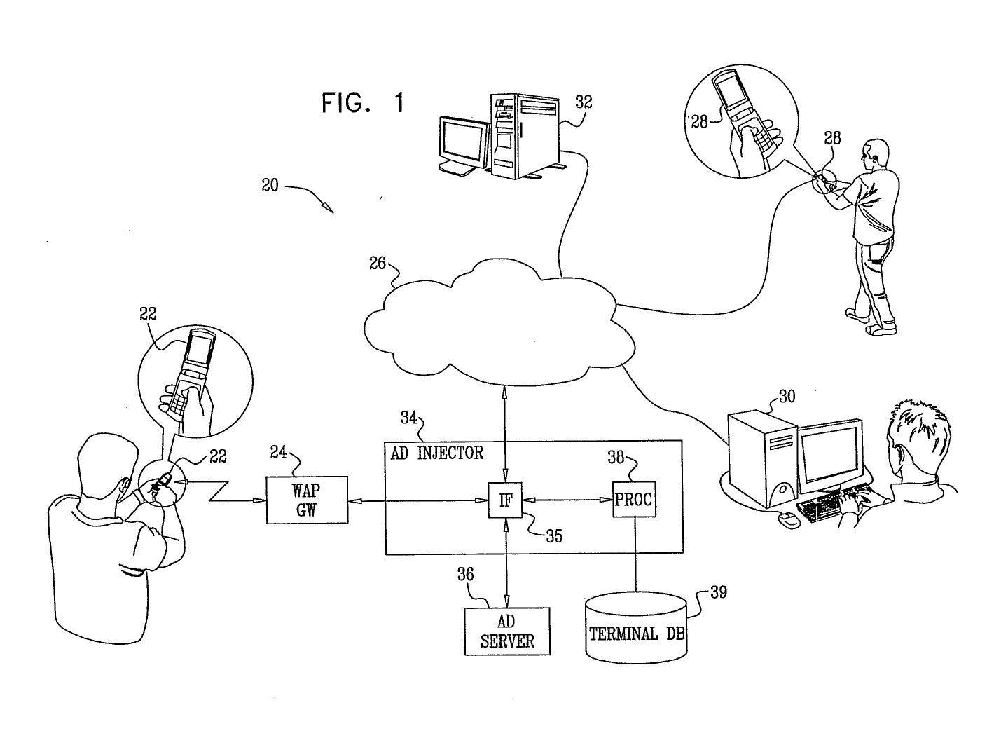

FIG. 1 is a block diagram that schematically illustrates a system 20 for content delivery, in accordance with an embodiment of the present invention. This system is shown here only to give an example of a setting in which the principles of the present invention may be applied. In practice, the methods that are described hereinbelow for conversion of a requested image into an image sequence may be applied in substantially any content delivery framework.

In system 20, a client terminal 22 is coupled to receive content via a gateway 24 from content sources 28, 30, 32 on a network 26. In the pictured example, terminal 22 comprises a cellular telephone, and gateway 24 is a Wireless Access Protocol (WAP) gateway. Alternatively, the client terminal may comprise any other suitable type of device with appropriate communication and display capabilities, such as a personal digital assistant (PDA) or personal computer, either portable or desktop. Similarly, any other suitable type of gateway, portal or proxy device may be used to deliver content to the terminal. Although FIG. 1, for the sake of simplicity, shows only a single client terminal, gateway 24 and the other components in system 20 are typically configured to serve multiple client terminals simultaneously. Network 26 may comprise a packet network, such as the Internet, or a circuit-switched telephone network, or a combination of packet and circuit-switched networks.

Gateway 24 typically delivers media content to terminal 22 in response to requests. For example, the user of terminal 22 may request a particular item of content, such as a certain still image, from a content server. As another example, another subscriber on network 26 may send a still image to terminal 22, in the form of a MMS message, for instance, or may submit a request to a server to deliver a certain image to terminal 22.

Content, such as images and other media objects, for delivery from network 26 to terminal 22 is first processed by an ad injector 34. The ad injector may be deployed in line, between network 26 and gateway 24, as shown in FIG. 1. In this configuration, the ad injector serves as a proxy, such as a Hypertext Transfer Protocol (HTTP) proxy or a MMS proxy, as are known in the art. In this case, the ad injector itself may detect and process requests for delivery of images to terminal 22. Alternatively, gateway 24 or another in-line component, such as a MMS Center (MMSC, not shown) may detect image delivery requests and refer the requests to the ad injector. In this case, the gateway or MMSC is connected to the ad injector via a suitable interface, such as a Standard Transcoding Interface (STI), as specified by the Open Mobile Alliance (available at the openmobilealliance.org Web site). As another alternative, the functions of ad injector 34 may be integrated into the WAP gateway, MMSC, or other network component.

Ad injector 34 comprises a communication interface 35, which connects to gateway 24 and possibly to network 26, and a processor 38. Typically, processor 38 comprises a general-purpose computer processor, which is programmed in software to carry out the functions that are described herein. This software may be downloaded to the processor in electronic form, over a network, for example. Alternatively or additionally, the software may be stored on tangible media, such as optical, magnetic, or electronic memory media. Further alternatively or additionally, some or all of the functions of the processor may be carried out by dedicated or programmable hardware logic circuits. Although processor 38 is shown and described herein as comprising a single processing unit within the ad injector, the functions of the processor may alternatively be distributed among multiple processing units within a single computing machine or multiple machines.

Upon receiving a requested image for delivery to client terminal 22, ad injector 34 retrieves a suitable advertisement from an ad server 36 for delivery with the requested image to the client terminal. (Although the ad server is shown here as a separate element, the functionality of the ad server may alternatively be integrated as a component of the ad injector.) The advertisement may have the form of one or more promotional images, or it may, alternatively or additionally, comprise text, which is then converted into an image by the ad server or ad injector.

The advertisement may be chosen arbitrarily, or it may be selected based on factors such as the content of the requested image and/or known characteristics of the user of terminal 22. In the latter case, any suitable method of targeted advertising that is known in the art may be used in choosing the advertisement (but methods used for such targeting are beyond the scope of the present invention). For the purpose of ad selection, the ad injector may access a terminal database 39, which contains information regarding terminal characteristics. Additionally or alternatively, the ad injector may access information in a user database (not shown) concerning characteristics of the users of the terminals themselves.

Processor 38 combines the requested image and the promotional image (or images) to create an image sequence in accordance with a moving picture format, such as an animation or video format. In order to combine the images effectively, it may be necessary to transcode one or both of the images to a common format and to adjust certain image parameters, as explained in greater detail hereinbelow. These functions may be carried out by processor 38 itself or by a separate transcoding server (not shown). The processor (or other server) may refer to terminal information in database 39 in order to choose the most appropriate format for the images to be delivered to terminal 22, based on factors such as display capabilities and memory capacity of the terminal.

Ad injector 34 then delivers the image sequence, via gateway 24, to terminal 22. When the terminal plays the image sequence, in accordance with the moving picture format, it displays both the requested image and the promotional image (or images) in sequence. Promotional images may be displayed either before the requested image or after the requested image, or both.

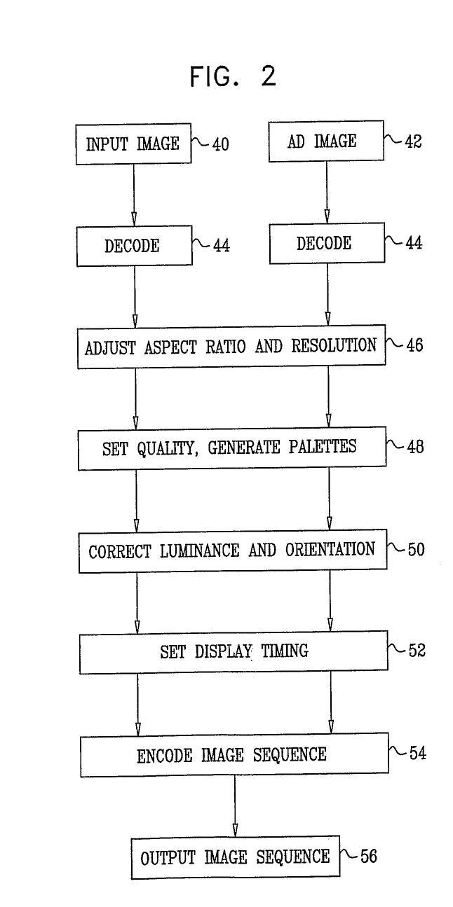

FIG. 2 is a flow chart that schematically illustrates a method by which ad injector 34 converts the requested image and promotional images into an image sequence in a moving picture format, such as an animation, in accordance with an embodiment of the present invention. The method begins with an input image 40 and a promotional image 42 (also referred to, for brevity, as an ad image). In the context of system 20, the input image is the still image that was requested for delivery to terminal 22, while the promotional image is provided by server 36. For clarity in the description that follows, it will be assumed that a single promotional image is to be combined with the requested image, but the present method may be extended in a straightforward manner to handle multiple ad images. For example, promotional images may be included in the image sequence both before and after the input image. As noted above, the promotional image may be stored by server 36 as an image, or it may comprise textual content, which is converted to an image for the present purposes.

Processor 38 optionally decodes images 40 and 42 to create raw data representations of the images, at a decoding step 44. For example, image 40 may be a JPEG-encoded image, while image 42 is a BMP-encoded image. Processor 38 may be configured to accept and decode both these and other formats, such as PNG, GIF, TIFF, MNG and JPEG2000. The raw data representation of the images may be a two-dimensional matrix of red, green and blue (RGB) pixels, for example. Alternatively, ad server 36 may provide the promotional image in a number of different formats, which may have different levels of quality and aspect ratio, for example, in which case processor 38 chooses the promotional image in the format that best matches the capabilities of terminal 22 (as listed in terminal database 39).

In converting textual content to a promotional image, processor 38 may likewise use attributes such as this sort of terminal capabilities information in choosing the appropriate image aspect ratio and size. Alternatively or additionally, the processor may choose the size or other parameters of the image format for the textual content based on image parameters of the still image.

Before combining the images into an animation or video sequence, processor 38 first adjusts image parameters of one or both images relative to the other so that the images visually fit together. It may be necessary, for example, for the processor to adjust the images to the same aspect ratio and resolution, at an image adjustment step 46. This step, as well subsequent processing steps, is typically controlled by general rules and strategies, which may be programmed in advance by an operator of the ad injector. These rules and strategies may be fixed, or they may vary depending on specific conditions, such as the known capabilities of terminal 22, user preferences, and characteristics of the requested image and promotional image. Thus, in the specific case of step 46, for example, the resolution and aspect ratio of the images may be set according to the display capabilities of terminal 22.

Several different approaches may be used by processor 38 at step 46. Assuming the input resolution of image 40 is (Hi, Wi) and that of image 42 is (Ha, Wa), wherein H and W represent the heights and widths of the images, respectively, the processor may adjust the image dimensions as follows:
If both images have the same aspect ratio, i.e., Hi/Wi=Ha/Wa, image resizing techniques that are known in the art may be used to increase or decrease resolution as required. Options for image resizing include the following examples:
   Image resolution may be reduced by cropping inessential parts of the image (without necessarily changing the aspect ratio), wherein informative parts of the image may be identified, for example, using face recognition, background recognition, or other image analysis techniques.
   One of the images may be selected as the resolution benchmark, and the resolution of the other image may be increased or reduced to match the benchmark. The benchmark may be either the image with the lower resolution or the higher resolution, although in the latter case, increasing the resolution of the lower-resolution image may give results that are not visually attractive.
   Alternatively, an intermediate resolution may be chosen, such as [(Hi+Ha)/2, (Wi+Wa)/2], and both images may be adjusted accordingly.
   In any case, the resolution that is selected may depend on the business model of the system operator or content publisher.
   Furthermore, one or both of the images may be resized according to terminal capabilities, such as screen size, maximum data size (in bytes, for example), or any other configurable terminal display size. As noted above, the promotional image may be chosen a priori depending on the aspect ratio of the terminal display and/or other terminal capabilities.
Alternatively, if the aspect ratios of images 40 and 42 are different, processor 38 adjusts one or both of the images so that they have equal aspect ratios, either prior to or in conjunction with the resolution adjustment techniques that are described above. In most cases, it can be assumed that attractive appearance of the promotional image must be preserved, so that only minimal or no adjustment of the aspect ratio of the promotional image is permitted. Options for adjustment of aspect ratios include the following:
   Crop image 40 to adjust its aspect ratio and then further resize and/or crop either or both of images 40 and 42, as described above.
   If the aspect ratios of the two images are close (for example, less than 10% difference) one or both of the images may be stretched in one dimension (horizontal or vertical).
   Add horizontal or vertical borders to one of the images, and then resize and/or crop either or both of the images, as described above.

Processor 38 selects the color quality of the image sequence, at a quality selection step 48. Specifically, assuming the image sequence is to be encoded in an animation format, for example, the processor chooses the palette (or palettes) to use in the animation. Common animation formats, such as GIF (Graphics Interchange Format) and MNG (Multiple-image Network Graphics), limit the number of colors to 256. In such formats, the colors (in the form of RGB triples) are stored in an array, known as a palette, and the image pixel values serve as indices to the relevant colors in the palette. A larger palette, with more colors, typically gives better quality, but increases the data volume of the encoded image.

Processor 38 converts the raw versions of the requested and promotional images to indexed images, with an appropriate palette, using a process known as “color quantization.” Various quantization techniques, as are known in the art, may be used for this purpose at step 48, such as the well-known “Median Cut” algorithm. The target animation format may require the use of a global palette for all the frames, or may possibly allow a dedicated palette for each frame, in which case the requested and promotional images may have separate palettes. File size constraints may also limit the palette size and may require that the images share the same palette. When the palette must be shared or file size is limited, one of the images (typically the promotional image) may have higher priority and thus gets a palette with the maximal range of allowed colors, while the other image may have to use the same palette or another palette with a reduced number of colors. In this case, the ratio of palette sizes between the two images may be configurable by an operator of the ad injector. Alternatively, the processor may compute a global palette to represent both images, although in general, again, palette size constraints are applied on the side of the requested image so that the quality of the promotional image is not significantly degraded.

Alternatively at step 48, if image 40 or 42 was retrieved from ad server 36 in a form that already had a palette (such as a GIF image), this palette may be used at step 48 rather than computing a new palette. If the image was resized at step 46, however, it may still be necessary to fix or recompute the palette, since resizing may cause color changes.

Processor 38 adjusts the luminance and orientation of the images, at an image correction step 50. It sometimes occurs, for example, that one of images 40 and 42 is much brighter than the other, so that the luminance histograms of the images are very different. The sharp change in brightness may be disturbing to the user of terminal 22 when the image sequence is displayed. To resolve this problem, processor 38 may modify the luminance histogram of the requested image to resemble that of the promotional image. Additionally or alternatively, the processor may adjust other image parameters, such as contrast or color saturation, in order to reduce the visual disparity between the images.

It is also desirable that the promotional and requested images have the same orientation (vertical or horizontal) when they are presented on terminal 22. If the orientations of the images are known in advance, processor 38 may apply a simple rotation operation to the requested image if necessary. Otherwise, image analysis may be applied in order to estimate the image orientation before performing image rotation. Alternatively, the image orientation may be adjusted, if necessary, at step 46 in order to avoid having to readjust the aspect ratio after image rotation.

Processor 38 sets the desired display times for the requested and promotional images in the moving picture format, at a time setting step 52. Common animation formats, for example, typically allow setting a different display time per frame when the animation is played. The promotional image may be emphasized by giving it a longer display time, either before or after the requested image, or it may be displayed for a short time, typically prior to the requested image. In addition, the processor may set the animation to enable looping, so that the advertisement is shown repeatedly for as long as the animation is displayed by terminal 22.

The processor may insert additional frames into the image sequence, as well. These frames may include, for example, a black frame as a separator between the advertisement and the requested image, or a title frame. A sequence of several frames may be used to generate transition effects. For example, an animation may start with the advertisement, fade out to a black frame over several frames, and than fade in to the requested image over several more frames. Alternatively, a “dissolve” effect may be created over several frames.

After adjusting the images and setting the parameters, processor 38 encodes the images together as an image sequence in accordance with a suitable moving picture format, at an encoding step 54. As noted earlier, the moving picture format may be a video format or an animation format. The processor may use any suitable encoding format that is supported by terminal 22, such as Animated GIF (AGIF). Ad injector 34 then outputs the image sequence to gateway 24, at an output step 56, and the gateway delivers the animation to the terminal for display in the moving picture format.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for content delivery, comprising:
receiving a request for delivery of a still image to a client terminal;
selecting a promotional image to be delivered to the client terminal together with the still image;
processing the still image and the promotional image together so as to create an image sequence containing the still image and the promotional image in a moving picture format; and
responsively to the request for delivery of the still image, delivering the image sequence over a network for display in the moving picture format by the client terminal.

2. The method according to claim 1, wherein processing the still image and the promotional image comprises adjusting at least one image parameter of at least one of the still image and the promotional image so as to generate an adjusted image, and incorporating the adjusted image in the image sequence.

3. The method according to claim 2, wherein adjusting the at least one image parameter comprises adjusting the at least one of the still image and the promotional image relative to the other of at least one of the still image and the promotional image.

4. The method according to claim 2, wherein adjusting the at least one image parameter comprises receiving an indication of a characteristic of the client terminal, and adjusting the at least one image parameter responsively to the characteristic.

5. The method according to claim 2, wherein the at least one image parameter is selected from a group of parameters consisting of an aspect ratio, a resolution, a palette, a brightness, a contrast, a color saturation, and an orientation.

6. The method according to claim 5, wherein adjusting the at least one image parameter comprises modifying at least one of the still image and the promotional image so that the still image and the promotional image have the same resolution and aspect ratio.

7. The method according to claim 1, wherein processing the still image and the promotional image comprises assigning respective display times of the still image and the promotional image in the image sequence.

8. The method according to claim 1, wherein processing the still image and the promotional image comprises introducing one or more additional frames into the image sequence so as to generate a transition effect between the promotional image and the still image.

9. The method according to claim 1, wherein selecting the promotional image comprises generating the promotional image by converting textual content to an image format.

10. The method according to claim 9, wherein converting the textual content comprises selecting a size of the image format for the textual content responsively to at least one attribute selected from a group of attributes consisting of image parameters of the still image and a characteristic of the client terminal.

11. The method according to claim 1, wherein the moving picture format comprises an animation format.

12. The method according to claim 1, wherein the moving picture format comprises a video format.

13. Apparatus for content delivery, comprising:
a communication interface; and
a processor, which is coupled to the communication interface so as to receive a request for delivery of a still image to a client terminal, and is configured to select a promotional image to be delivered to the client terminal together with the still image, to process the still image and the promotional image together so as to create an image sequence containing the still image and the promotional image in a moving picture format, and to deliver the image sequence, responsively to the request for delivery of the still image, over a network for display by the client terminal in the moving picture format.

14. The apparatus according to claim 13, wherein the processor is configured to adjust at least one image parameter of at least one of the still image and the promotional image so as to generate an adjusted image, and to incorporate the adjusted image in the image sequence.

15. The apparatus according to claim 14, wherein the processor is configured to adjust the at least one of the still image and the promotional image relative to the other of at least one of the still image and the promotional image.

16. The apparatus according to claim 14, wherein the processor is coupled to receive an indication of a characteristic of the client terminal, and to adjust the at least one image parameter responsively to the characteristic.

17. The apparatus according to claim 14, wherein the at least one image parameter is selected from a group of parameters consisting of an aspect ratio, a resolution, a palette, a brightness, a contrast, a color saturation, and an orientation.

18. The apparatus according to claim 17, wherein the processor is configured to modify at least one of the still image and the promotional image so that the still image and the promotional image have the same resolution and aspect ratio.

19. The apparatus according to claim 13, wherein the processor is configured to assign respective display times of the still image and the promotional image in the image sequence.

20. The apparatus according to claim 13, wherein the processor is configured to introduce one or more additional frames into the image sequence so as to generate a transition effect between the promotional image and the still image.

21. The apparatus according to claim 13, wherein the processor is configured to generate the promotional image by converting textual content to an image format.

22. The apparatus according to claim 21, wherein the processor is configured to select a size of the image format for the textual content responsively to at least one attribute selected from a group of attributes consisting of image parameters of the still image and a characteristic of the client terminal.

23. The apparatus according to claim 13, wherein the moving picture format comprises an animation format.

24. The apparatus according to claim 13, wherein the moving picture format comprises a video format.

25. A computer software product, comprising a computer-readable medium in which program instructions are stored, which instructions, when read by a computer processor, cause the processor to receive a request for delivery of a still image to a client terminal, and to select a promotional image to be delivered to the client terminal together with the still image, to process the still image and the promotional image together so as to create an image sequence containing the still image and the promotional image in a moving picture format, and to deliver the image sequence, responsively to the request for delivery of the still image, over a network for display by the client terminal in the moving picture format.

26. The product according to claim 25, wherein the instructions cause the processor to adjust at least one image parameter of at least one of the still image and the promotional image so as to generate an adjusted image, and to incorporate the adjusted image in the image sequence.

27. The product according to claim 26, wherein the instructions cause the processor to adjust the at least one of the still image and the promotional image relative to the other of at least one of the still image and the promotional image.

28. The product according to claim 26, wherein the instructions cause the processor to receive an indication of a characteristic of the client terminal, and to adjust the at least one image parameter responsively to the characteristic.

29. The product according to claim 26, wherein the at least one image parameter is selected from a group of parameters consisting of an aspect ratio, a resolution, a palette, a brightness, a contrast, a color saturation, and an orientation.

30. The product according to claim 29, wherein the instructions cause the processor to modify at least one of the still image and the promotional image so that the still image and the promotional image have the same resolution and aspect ratio.

31. The product according to claim 25, wherein the instructions cause the processor to assign respective display times of the still image and the promotional image in the image sequence.

32. The product according to claim 25, wherein the instructions cause the processor to introduce one or more additional frames into the image sequence so as to generate a transition effect between the promotional image and the still image.

33. The product according to claim 25, wherein the instructions cause the processor to generate the promotional image by converting textual content to an image format.

34. The product according to claim 33, wherein the instructions cause the processor to select a size of the image format for the textual content responsively to at least one attribute selected from a group of attributes consisting of image parameters of the still image and a characteristic of the client terminal.

35. The product according to claim 25, wherein the moving picture format comprises an animation format.

36. The product according to claim 25, wherein the moving picture format comprises a video format.
